(19) United States
(12) Patent Application Publication
(10) Pub. No.: US 2024/0347739 A1
(43) Pub. Date: Oct. 17, 2024

(54) INERT ATMOSPHERE SINTERING OF ELECTROCHEMICAL CELL STACK INTERCONNECTS

(71) Applicant: BLOOM ENERGY CORPORATION, San Jose, CA (US)

(72) Inventors: Zigui LU, San Jose, CA (US); Guoliang XIAO, Fremont, CA (US); Tad ARMSTRONG, Burlingame, CA (US); Keji PAN, Pleasanton, CA (US); Adam BYRD, Sunnyvale, CA (US)

(21) Appl. No.: 18/624,584

(22) Filed: Apr. 2, 2024

Related U.S. Application Data
(60) Provisional application No. 63/495,591, filed on Apr. 12, 2023.

(51) Int. Cl. H01M 8/0215; C04B 24/38; C04B 35/64; C04B 41/50; H01M 8/12; H01M 8/2404

(52) U.S. Cl. CPC H01M 8/0215; C04B 24/383; C04B 35/64; C04B 41/5046; H01M 8/12; H01M 8/2404; C04B 2235/3262; C04B 2235/3272; C04B 2235/3275; C04B 2235/3279; C04B 2235/3281; C04B 2235/6585; H01M 2008/1293

(57) ABSTRACT

A method of forming a protective layer on an interconnect for an electrochemical cell stack includes coating at least one side of the interconnect with a metal oxide powder to form a protective layer, sintering the coated interconnect in an inert atmosphere to at least partially reduce the protective layer, and oxidizing the sintered interconnect in an oxidizing atmosphere to oxidize and densify the protective layer.

### FIELD

Aspects of the present disclosure relate generally to electrochemical cell stack (e.g., fuel cell stack or electrolyzer stack) component manufacturing methods, and in particular, to interconnect manufacturing methods that include inert atmosphere sintering.

### BACKGROUND

A typical solid oxide fuel cell stack includes multiple fuel cells separated by metallic interconnects (ICs) which provide both electrical connection between adjacent cells in the stack and channels for delivery and removal of fuel and oxidant. The metallic interconnects are commonly composed of a Cr-based alloys such as CrFe alloys, which have a composition of 95 weight percent (“wt %”) Cr-5 wt % Fe or Cr—Fe—Y having a 94 wt % Cr-5 wt % Fe-1 wt % Y composition. The CrFe and CrFeY alloys retain their strength and are dimensionally stable at typical solid oxide fuel cell (SOFC) operating conditions, e.g., 700-900° C. in both air and wet fuel atmospheres.

### SUMMARY

According to various embodiments, a method of forming a protective layer on an interconnect for an electrochemical cell stack includes coating at least one side of the interconnect with a metal oxide powder to form a protective layer, sintering the coated interconnect in an inert atmosphere to at least partially reduce the protective layer, and oxidizing the sintered interconnect in an oxidizing atmosphere to oxidize and densify the protective layer.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a perspective view of an electrochemical cell stack, according to various embodiments of the present disclosure.

FIG. 1B is a cross-sectional view of a portion of the stack of FIG. 1A.

FIG. 2A is a top view of an air side of an interconnect, according to various embodiments of the present disclosure.

FIG. 2B is a top view of a fuel side of the interconnect of FIG. 2A.

FIG. 3 is a three dimensional view of an electrochemical cell column, according to various embodiments of the present disclosure.

FIG. 4 is a flow diagram depicting a method of fabricating a coated interconnect and/or an electrochemical cell stack of FIGS. 1A and 1B, according to various embodiments of the present disclosure.

FIG. 5 is a flow diagram depicting an alternative method of fabricating a coated interconnect and/or electrochemical cell stack of FIGS. 1A and 1B, according to various embodiments of the present disclosure.

FIG. 6 is a flow diagram depicting another method of fabricating a coated interconnect and/or electrochemical cell stack of FIGS. 1A and 1B, according to various embodiments of the present disclosure.

FIGS. 7A and 7B are micrographs of the protective layer according to an example of the present disclosure.

### DETAILED DESCRIPTION

The present disclosure is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Electrochemical cell systems include fuel cell and electrolyzer cell systems. In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be a hydrogen (H₂) or a hydrocarbon fuel, such as methane, natural gas, ethanol, or methanol. The fuel cell, operating at a typical temperature between 750° C. and 950° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit. In an electrolyzer system, such as a solid oxide electrolyzer system, water (e.g., steam) is separated into hydrogen and oxygen by applying a voltage across the electrolyzer cells.

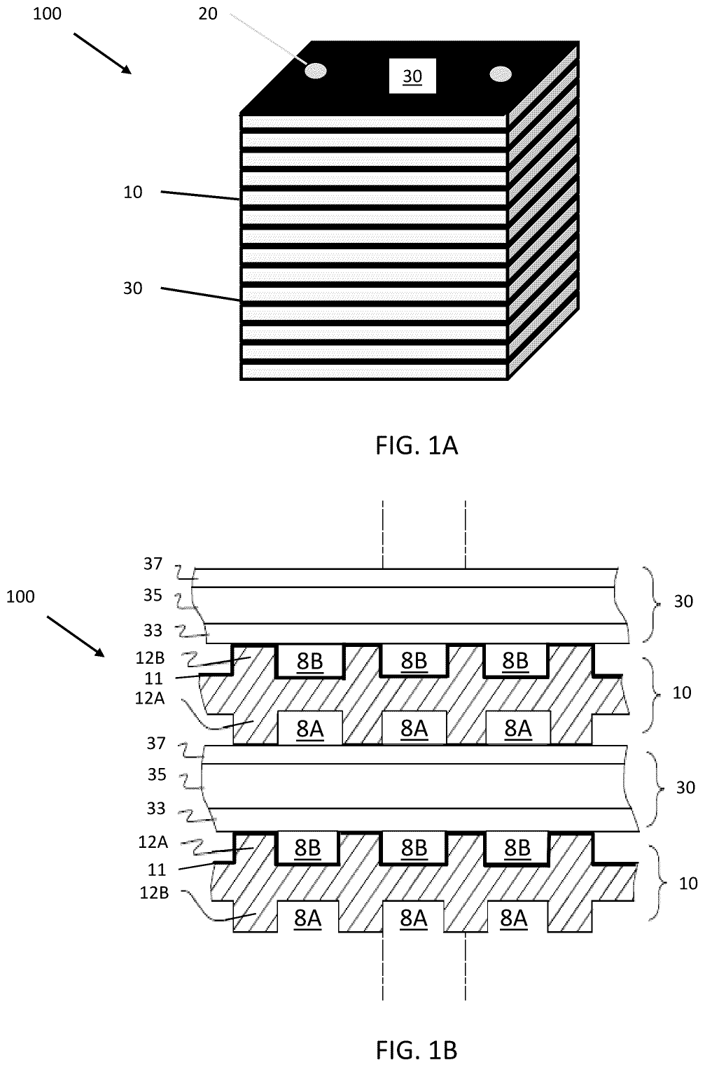

FIG. 1A is a perspective view of an electrochemical cell stack 100 and FIG. 1B is a sectional view of a portion of the stack 100, according to various embodiments of the present disclosure. In the embodiments below, the stack 100 is described as being operated as a solid oxide fuel cell (SOFC) stack 100. However, it should be noted that the stack 100 may also be operated as an electrolyzer (e.g., a solid oxide electrolyzer cell (SOEC) stack). Referring to FIGS. 1A and 1B, the stack 100 includes fuel cells 30 separated by interconnects 10. Referring to FIG. 1B, each fuel cell 30 comprises a cathode electrode 33, a solid oxide electrolyte 35, and an anode electrode 37.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 33 may also contain a ceramic phase similar to the anode electrode 37. The electrodes and the electrolyte may each comprise one or more sublayers of one or more of the above described materials.

Fuel cell stacks 100 are frequently built from a multiplicity of SOFC's 30 in the form of planar elements, tubes, or other geometries. Although the fuel cell stack in FIG. 1A is vertically oriented, fuel cell stacks may be oriented horizontally or in any other direction. Fuel and air may be provided to the electrochemically active surfaces, which can be large. For example, fuel may be provided through fuel holes 20 formed in each interconnect 10. The fuel holes 20 may be aligned to form fuel conduits (i.e., fuel riser openings) that extend through the stack 100.

Each interconnect 10 electrically connects adjacent fuel cells 30 in the stack 100. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent (“wt %”) iron, optionally 1 or less weight percent yttrium and balance chromium and may electrically connect the anode or fuel-side of one fuel cell 30 to the cathode or air side of an adjacent fuel cell 30. Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt % Cr, less than 1 wt % Mn, Ti and La, and balance Fe, or ZMG™ 232L alloy which contains 21 to 23 wt % Cr, 1 wt % Mn and less than 1 wt % Si, C, Ni, Al, Zr and La, and balance Fe),

An electrically conductive contact layer, such as a nickel layer or mesh, may be provided between anode electrodes 37 and a fuel side of each interconnect 10. An electrically conductive protective layer 11, as described in detail below, may be provided on at least an air side of each interconnect 10.

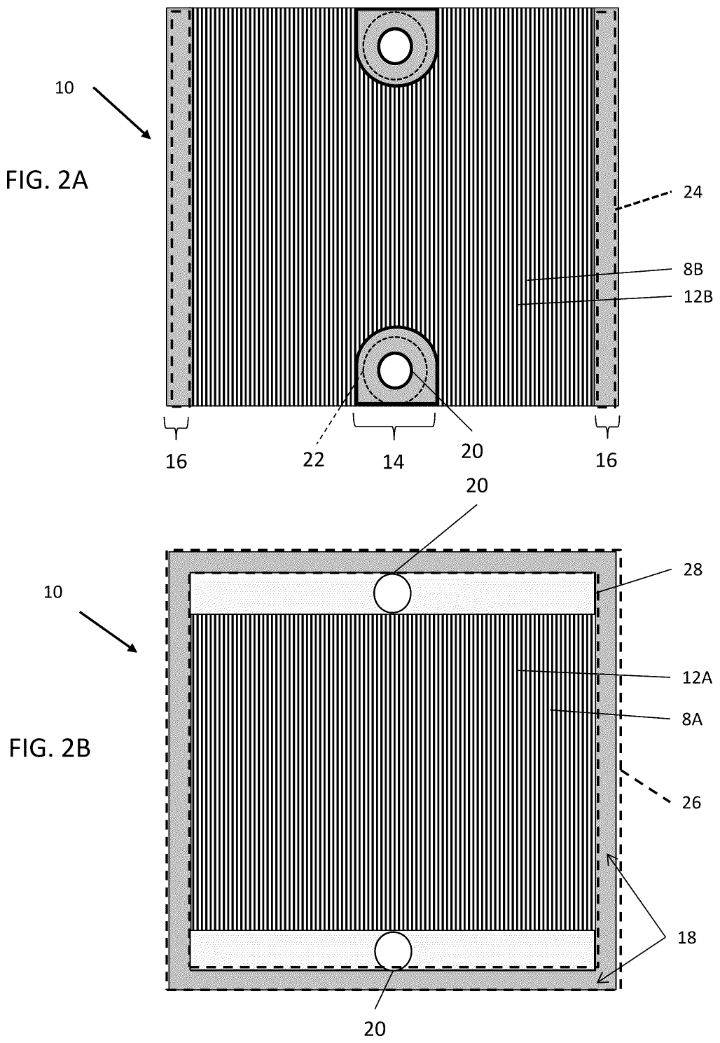

FIG. 2A is a top view of the air side of the interconnect 10, and FIG. 2B is a top view of a fuel side of the interconnect 10, according to various embodiments of the present disclosure. Referring to FIGS. 1B and 2A, the air side includes the air channels 8B. Air flows through the air channels 8B to a cathode electrode 33 of an adjacent fuel cell 30. The interconnect 10 may include ring seal regions 14 and strip seal regions 16. The seal regions 14, 16 may be flat surfaces that are coplanar with the tops of the air ribs 12B. Fuel holes 20 may be formed in the ring seal regions 14 and may extend through the interconnect 10. Ring seals 22 may be disposed on the ring seal regions 14 surrounding the fuel holes 20, to prevent fuel from contacting an adjacent cathode electrode 33. Strip seals 24 may be disposed on the strip seal regions 16. The seals 22, 24 may be formed of a glass or glass-ceramic material. The strip seal regions 16 may be an elevated plateau which does not include ribs or channels.

Referring to FIGS. 1B and 2B, the fuel side of the interconnect 10 may include the fuel channels 8A and fuel manifolds 28, which are surrounded by a frame seal region 18. The frame seal region 18 may be a flat region that is coplanar with the tops of the fuel ribs 12A. Fuel flows from one of the fuel holes 20 (e.g., inlet hole that forms part of the fuel inlet riser), into the adjacent manifold 28, through the fuel channels 8A, and to an anode 37 of an adjacent fuel cell 30. Excess fuel may flow into the other fuel manifold 28 and then into the other (e.g., outlet) fuel hole 20. A frame seal 26 may be disposed on the frame seal region 18. The frame seal 26 may be formed of a glass or glass-ceramic material.

Fuel is delivered through one of the fuel holes 20 to a corresponding manifold 28 that distributes the fuel to each fuel channel 8A. Fuel flows down each fuel channel 8A. Any unreacted fuel is collected in the other manifold 28 and exits the stack via the other fuel hole 20. This flow channel geometry may be optimized for operation on natural gas with partial external pre-reforming.

While a co-flow or counter-flow interconnect 10 is illustrated in FIGS. 2A and 2B, in alternative embodiments, the interconnect 10 may comprise a cross-flow interconnect in which the air and fuel channels extend perpendicular to each other, as described in U.S. Pat. No. 11,355,762 B2, which is incorporated herein by reference in its entirety. For example, such interconnects 10 may include two or more fuel holes 20 per side of the interconnect.

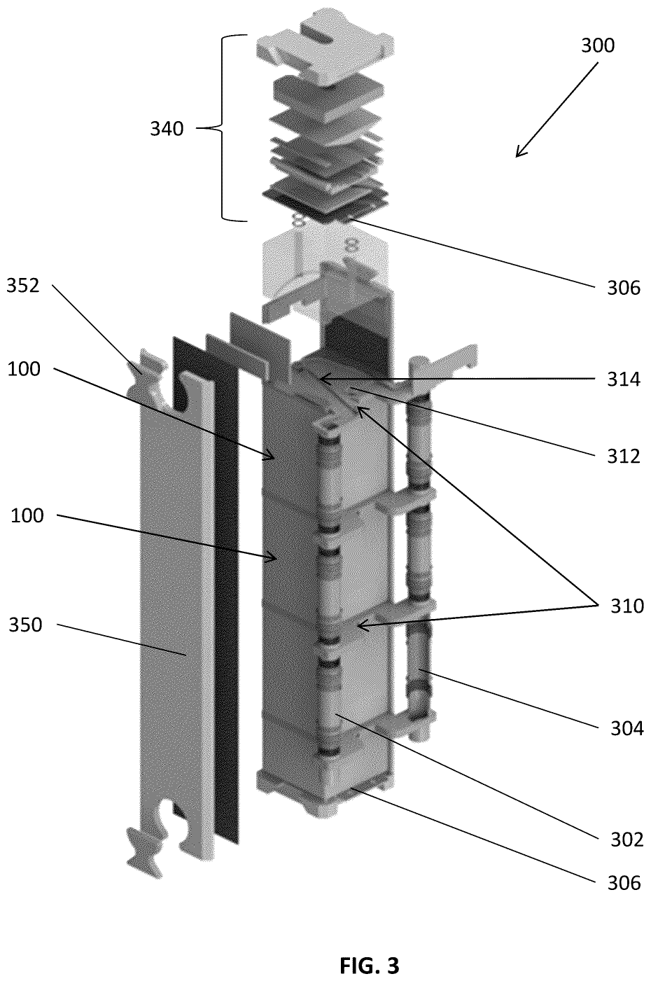

FIG. 3 is a perspective view of a fuel cell column 300, according to various embodiments of the present disclosure. Referring to FIG. 3, the fuel cell column 300 may include multiple fuel cell stacks 100, a fuel inlet conduit 302, an anode exhaust conduit 304, termination plates 306, and fuel manifolds 310 (e.g., anode splitter plates). The fuel inlet conduit 302 is fluidly connected to the fuel manifolds 310 and is configured to provide the fuel feed to each fuel manifold 310, and anode exhaust conduit 304 is fluidly connected to the fuel manifolds 310 and is configured to receive anode fuel exhaust from each fuel manifolds 310.

The fuel manifolds 310 may be disposed between the stacks 100 and may be configured to provide a fuel feed to the stacks 100 and to receive anode fuel exhaust from the stacks 100. For example, the fuel manifolds 310 may be fluidly connected to internal fuel riser channels formed by aligning the fuel holes 20 of the interconnects 10, as discussed above. In particular, the fuel manifolds 310 may include fuel holes 312 that are vertically aligned with the fuel riser channels/fuel holes 20, and fuel channels 314 that fluidly connect the fuel holes 312 with the respective fuel inlet conduit 302 and the anode exhaust conduit 304. In an alternative embodiment, the external fuel inlet conduit 302, the external anode exhaust conduit 304, and the fuel manifolds 310 may be omitted, as described in U.S. Pat. No. 11,355,762 B2, which is incorporated herein by reference in its entirety.

The fuel cell column 300 may also include a compression assembly 340 and side baffles 350 disposed on opposing sides of the fuel cell stacks 100. The side baffles 350 may be formed of a ceramic material and may be connected to the compression assembly 340 and an underlying stack component (not shown) by ceramic connectors 352. The compression assembly 340 may be configured to apply pressure to and/or compress the stacks 100, so as to seal the stacks 100 to adjacent components (e.g., the fuel manifolds 310).

Each stack 100 may include any suitable number of interconnects 10, such as from 5 to 40 interconnects 10, or from 10 to 35 interconnects 10, and a corresponding number of fuel cells 30 disposed therebetween. The stacks 100 may also include conductive layers, such as a nickel mesh, disposed between the fuel side of each interconnect 10 and the anode 37 of an adjacent fuel cell 30, to electrically connect the fuel cells 30 and interconnects 10 of the stack 100.

### Interconnect and Electrochemical Cell Stack Manufacturing

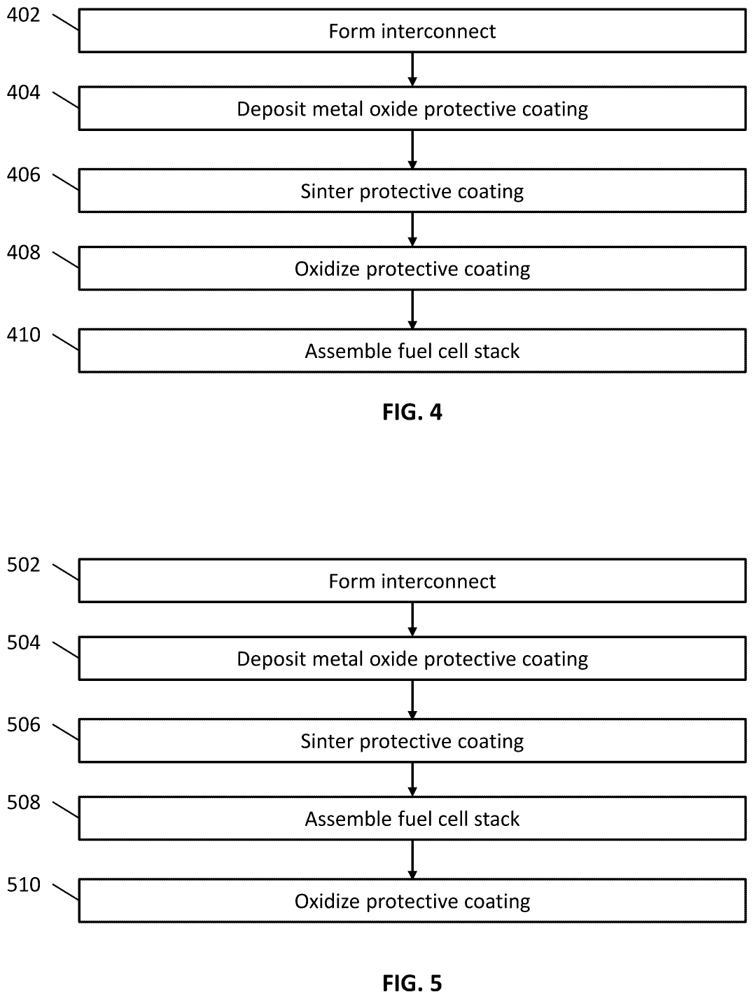

FIG. 4 is a flow diagram depicting a method of fabricating a coated interconnect 10 and/or an electrochemical fuel cell stack 100 of FIGS. 1A and 1B, according to various embodiments of the present disclosure. Referring to FIGS. 1A, 1B, and 4, in step 402, uncoated interconnects 10 (e.g., metallic interconnect substrates) may be provided. In some embodiments, the interconnects 10 may be formed using any suitable method, such as powder metallurgy. For example, a Cr-based interconnect alloy powder, such as a CrFe alloy powder and/or a mixture of Cr and Fe powders, may be loaded into a die cavity of a powder press apparatus and then pressed to form an interconnect. In some embodiments, the interconnect powder may have a composition of 95 wt % Cr-5 wt % Fe or a composition of Cr—Fe—Y having 94 wt % Cr-5 wt % Fe-1 wt % Y, for example. In one embodiment, the pressed interconnects (i.e., the “green” interconnects) 10 may then be sintered at an elevated temperature.

In step 404, a protective layer 11 may be formed on at least the air side of the interconnects 10. However, in some embodiments, protective layers 11 may be applied to both the fuel side and the air side of the interconnects 10. The protective layer 11 may be applied to either sintered interconnects 10 or to unsintered “green” interconnects. The protective layer 11 layer may be formed by applying a metal oxide powder or its precursor to the interconnects 10 using any suitable coating method. Preferably, a wet coating method, such as spraying (i.e., spray coating a powder suspension on the interconnects 10), screen printing, dip coating, or the like, may be used to apply the protective layers 11. At least one organic material (e.g., cellulose (such as ethyl cellulose for example), arylates, citric acid, polyvinyl alcohol, and/or polyvinyl butyral) and/or carbon material (e.g., graphite, carbon black, activated carbon, and/or graphene) may be added to the suspension to aid the coating process. After coating, the protective layer 11 may be dried to remove the coating solvent, such as water. In one embodiment, the organic material (if present) may be removed from the protective layer during the drying step and/or during a subsequent heating step. In an alternative embodiment, at least one organic material may remain in the protective layer 11 after the drying step to induce reduction of metal oxides during the subsequent sintering step. In some embodiments, at least 2 wt % of ethyl cellulose, such as 3 to 7 wt %, for example 5 wt % of ethyl cellulose remains in the protective layer 11. For example, the composition of the protective layer 11 after the drying step may comprise 90 wt % of metal oxide(s), 5 wt % of ethyl cellulose and 5 wt % of other ingredients. To further facilitate the reduction of metal oxides and/or promote densification of the protective layer 11, at least one carbon material (e.g., graphite, carbon black, active carbon, and/or graphene) may be present in the protective layer 11 after the drying step. In some embodiments, at least 0.2 wt %, such as at least 0.5 wt % of the carbon material, such as 1 to 5 wt %, for example 3 wt % of the carbon material remains in the protective layer 11. For example, the protective layer 11 contains 3 wt % of graphite, 3 wt % of ethyl cellulose and 90 wt % of metal oxide(s) and 4 wt % of other ingredients after the drying step.

According to various embodiments, the protective layer 11 may comprise at least one spinel transition metal oxide. For example, the protective layer 11 may comprise spinel oxides of Cu, Co, Fe, Mn and/or Ni, or the like. In other embodiments, the protective layer 11 may be formed by depositing other oxides of Cu, Ni, Co, Fe, and Mn, which may be mixed in various ratios suitable for forming spinel phases of the protective layer 11. The protective layer 11 may also optionally include a relatively small amount (e.g., less than 5 wt %, such as from about 0.5 wt % to about 3 wt %) or of one or more adhesion promoting elements such as Mg, Y, Ce, La, Sm, Zr, and/or oxides thereof, to increase the adhesion of the protective layer 11 to the oxide scale of the interconnect 10. In other embodiments, the protective layer 11 may have a structure other than a spinel structure, such as for example a perovskite structure.

In sintering step 406, the protective layers 11 may be sintered in an inert atmosphere (e.g., an Ar, N₂, or other oxygen-free atmosphere) to densify and at least partially reduce the protective layers 11. If the interconnects 10 comprise unsintered “green” interconnects after step 404, then the interconnects 10 may be sintered together with the protective layers 11 during step 406.

In particular, the coated interconnects 10 may be loaded into a furnace, such as a continuous or batch furnace containing the inert atmosphere. The inert atmosphere may contain less than 0.1 volume percent of any oxidizing gas, such as oxygen. In one embodiment, the inert atmosphere may also contain less than 0.1 volume percent of any reducing gas, such as hydrogen. Thus, the inert atmosphere may comprise at least 99.9 volume percent nitrogen and/or noble gas (e.g., Ar, He, Ne, Kr and/or Xe, etc.).

When comparing the equilibrium partial pressure of oxygen (pO₂) of the transition metals of the protective layers 11 with their simple oxides, the transition metals may be ordered in stability from Cu<Ni<Co<Fe<Mn<Cr. That is, Cu is the most easily reduced while Cr is the hardest to reduce. While not wishing to be bound by a particular theory, during the sintering in the inert atmosphere, it is likely that one or more of the transition metal species is reduced to metallic form, while at least one other transition metal remains as a metal oxide, based on the stability thereof.

In various embodiments, in order to facilitate the at least partial reduction of the protective layers 11 and/or to promote the formation of a densified metal oxide (e.g., spinel) phase, the metal oxide powder may include a relatively easily reduced first component including a transition metal selected from oxides of Cu, Ni, and/or Co (e.g., copper oxide, nickel oxide and/or cobalt oxide) and a relatively hard to reduce second component including a transition metal selected from Fe and/or Mn (e.g., iron oxide and/or manganese oxide). In some embodiments, the sintering may include reducing at least about 95 wt %, such as at least about 99 wt % of the first component and less than 5 wt %, such as 0 to 1 wt % of the second component.

The sintering may occur at a temperature ranging from about 800° C. to about 950° C., such as from about 900° C. to about 950° C., or from about 930° C. to about 945° C., or at about 940° C. Sintering times may range from about 3 hours to about 10 hours, such as from about 4 hours to about 6 hours, or about 5 hours. However, sintering at temperatures of below about 950° C. may not fully densify the protective coatings 11. For example, the sintered protective layers 11 may not be sufficiently densified to fully prevent the evaporation of chromium from the interconnects 10.

Accordingly, in step 408, the sintered protective coatings 11 may be oxidized. In particular, the sintered interconnects 10 may be loaded in a furnace, such as a continuous or batch furnace containing an oxidizing atmosphere (e.g., air or oxygen). In one embodiment, the oxidation may include heating the protective coatings 11 on the interconnects 10 at a temperature that is higher than the sintering temperature. For example, the oxidation process may include heating the interconnects 10 at temperature of at least 950° C., such as a temperature ranging from about 950° C. to about 1000° C., such as from about 950° C. to about 980° C., from about 950° C. to about 960° C., or about 950° C. Oxidizing times may range from about 3 hours to about 10 hours, such as from about 4 hours to about 6 hours, or about 5 hours.

During the oxidation process, the reduced metal component (e.g., Cu, Ni and/or Co) of the protective layers 11 may be re-oxidized. As a result, the porosity of the protective layers 11 may be reduced and the density of the protective layers 11 may be increased. As such, the protective layers 11 may have a density sufficient to reduce and/or prevent chromium diffusion from the interconnects 10.

In step 410, the method may optionally include assembling solid oxide fuel cells 30 between oxidized interconnects 10 to form a fuel cell stack 100. For example, glass or glass ceramic seals 22, 24, 26 (see FIGS. 2A and 2B) may be disposed between the interconnects 10 and the fuel cells 30. Step 410 may additionally include conditioning the fuel cell stack 100 at a temperature sufficient to reflow the seals 22, 24, 26 and seal the stack 100.

In various embodiments, the protective layer 11 may comprise Mn_{1.5}Co_{1.5}O₄ (MCO) spinel, however, any other manganese cobalt spinels may be used, such as Mn₂₋ₓCo₁₊ₓO₄, wherein 0<x<1, including Mn₂CoO₄, Mn_{1.5}Co_{1.5}O₄, and MnCo₂O₄. The protective layer 11 may also include transition metals such as Cu, Cu, Fe, and/or Ni instead of or in addition to Mn and Co.

For example, the protective layer 11 may include binary, ternary, or even quaternary oxides, such as: Cu_{0.5+x}Mn_{2.5-x}O₄, wherein 0≤x≤1, NiCo₂₋ₓFeₓO₄, wherein 0≤x≤1, (Mn, Co, Fe)₃O₄, (Mn, Co, Cu)₃O₄, (Mn, Co, Ce)₃O₄, (Mn, Co, Cu, Ce)₃O₄, (Mn, Fe, Cu)₃O₄, and (Mn, Co, Fe, Cu)₃O₄. Specific examples of such compound oxides include, but are not limited to, Mn_{1.5}Co_{1.5}O₄, Mn_{1.475}Co_{1.475}Ce_{0.05}O₄, Ni_{0.9}Fe_{2.1}O₄, NiCoFeO₄, Cu_{1.3}Mn_{1.7}O₄, CuMn₂O₄, MnCu_{0.5}Co_{1.5}O₄, MnCo_{1.7}Fe_{0.3}O₄, CoFe₂O₄, MnCo_{1.7}Cu_{0.3}O₄, Mn_{1.4}Co_{1.4}Cu_{0.2}O₄, Mn₂Fe_{0.7}Mg_{0.1}Cu_{0.1} Y_{0.1}O₄, and Cu_{0.77}Ni_{0.45}Mn_{1.78}O₄.

The sintering and oxidation of steps 406 and 408 may be performed on a component level or in-situ in an assembled electrochemical cell stack. For example, at a component level, the coated and dried interconnect 10 may be sintered in a continuous or batch furnace having an inert atmosphere. The sintered interconnect 10 may then be oxidized in the same or different continuous or batch furnace in an oxidizing atmosphere.

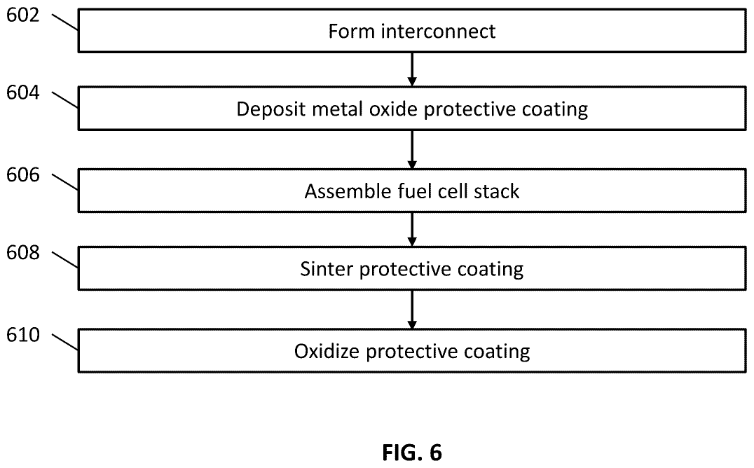

FIG. 5 is a flow diagram depicting an alternative method of fabricating a coated interconnect and/or an electrochemical cell stack 100 of FIG. 1A including interconnects 10 of FIG. 1B, according to various embodiments of the present disclosure. The method of FIG. 5 may be similar to the method of FIG. 4. As such, only the differences therebetween will be discussed in detail.

Referring to FIGS. 1A, 1B, and 5, in steps 502, 504, and 506, the interconnects 10 may be fabricated, coated with the protective layer 11, and sintered, as described with respect to steps 402, 404, and 406 of FIG. 4.

In step 508, the sintered interconnects 10 may be assembled with fuel cells 30 to form the electrochemical cell stack 100, as disclosed with respect to operation 410 of FIG. 4. In step 510, the protective layers 11 may be oxidized in-situ in the stack 100. In particular, the protective layers 11 may be oxidized during operation and/or testing of the stack 100, while the stack 100 is provided with a fuel and an oxidant, such as air.

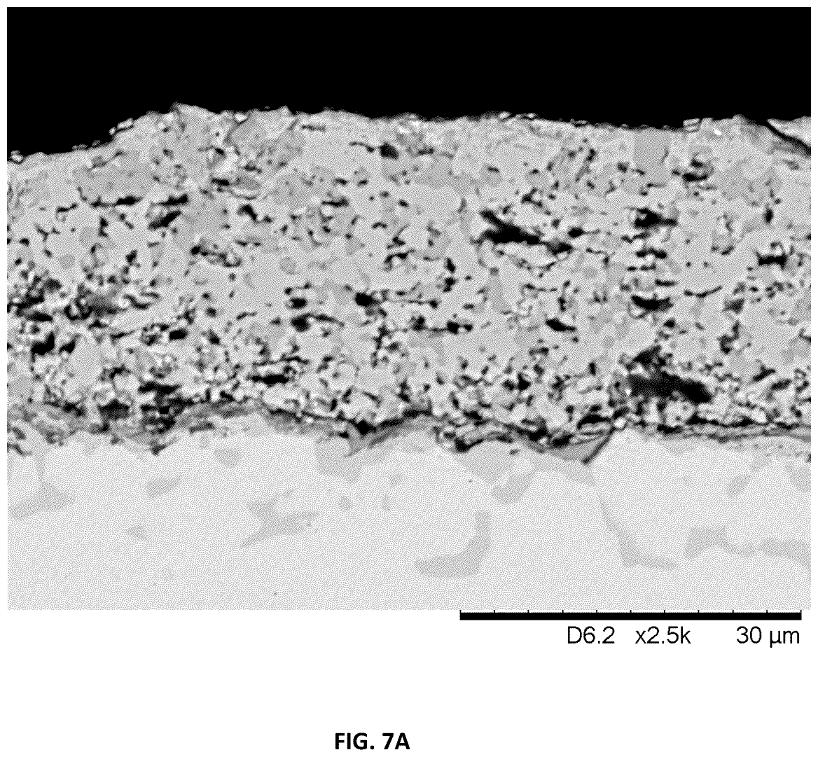

FIG. 6 is a flow diagram depicting an alternative method of fabricating a coated interconnect and/or an electrochemical cell stack 100 of FIG. 1A including interconnects 10 of FIG. 1B, according to various embodiments of the present disclosure. The method of FIG. 6 may be similar to the method of FIG. 4. As such, only the differences therebetween will be discussed in detail.

Referring to FIGS. 1A, 1B, and 6, in steps 602 and 604, the interconnects 10 may be fabricated and coated with the protective layer 11, as described with respect to steps 402 and 404 of FIG. 4.

In step 606, the coated interconnects 10 may be assembled with the fuel cells 30 to form the electrochemical cell stack 100, as disclosed with respect to step 410 of FIG. 4. In step 608, the protective layers 11 may be sintered in situ in the stack 100. In particular, the stack 100 may be heated in an inert atmosphere, to sinter the protective layers 11 and/or other components of the stack 100. For example, the stack 100 may be disposed in a furnace containing the inert atmosphere and heated. The sintering may include reflowing of glass seals of the stack 100. The sintering conditions may be as described above with respect to step 406 of FIG. 4.

In step 610, the protective layers 11 may be oxidized in situ in the stack 100. In particular, the protective layers 11 may be oxidized during operation and/or testing of the stack 100, while providing a fuel and an oxidant to the stack 100.

According to various embodiments, the present inventors discovered that the addition of relatively easy to reduce metal oxides, such as copper oxide, nickel oxide and/or cobalt oxide to the protective layer 11 unexpectedly results in at least a partial reduction of the protective layer 11 in an inert atmosphere, such as a reduction of copper oxide, nickel oxide and/or cobalt oxide to copper, nickel and/or cobalt metal, while the additional metal oxide (e.g., manganese oxide and/or iron oxide) in the protective layer 11 remains as an oxide without being reduced to a metal. In particular, this finding was contrary to the conventionally held belief that metal oxide reduction requires a reducing atmosphere (e.g., a hydrogen containing ambient atmosphere).

Various embodiments may also provide additional benefits in comparison to conventional manufacturing processes. For example, sintering and reduction in an inert atmosphere is significantly less costly than utilizing a reducing atmosphere. The presently disclosed methods also allow for lower processing temperatures and higher material utilization rates, as compared to using conventional air plasma spray processes to form a protective layer.

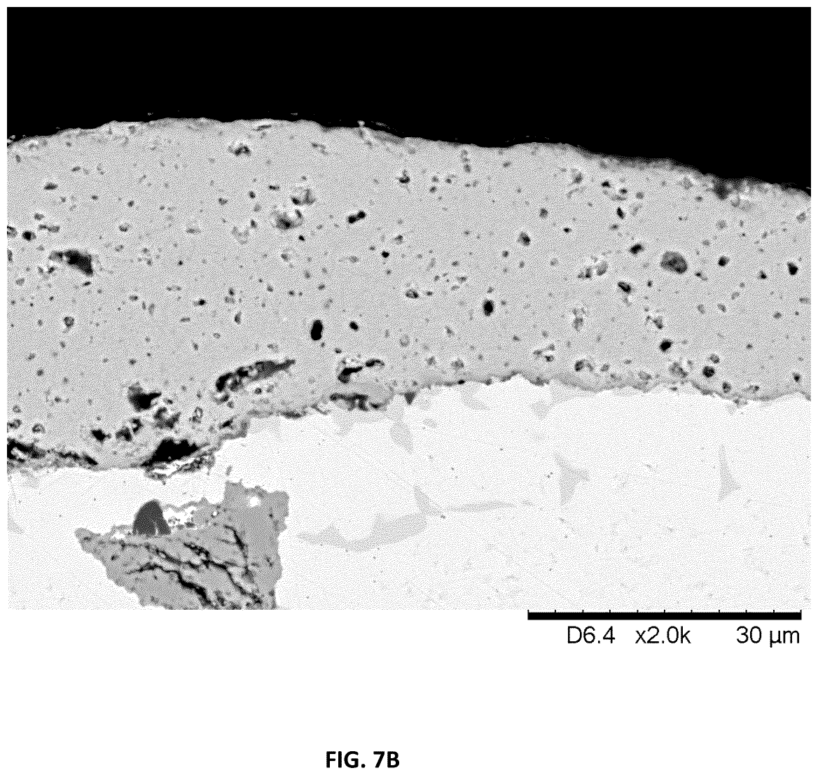

FIGS. 7A and 7B are micrographs of the protective layer according to a non-limiting example of the present disclosure. FIG. 7A is a micrograph of an MCO protective layer that includes 1 wt % graphite after sintering in a nitrogen inert atmosphere. FIG. 7B is a micrograph of the MCO protective layer of FIG. 7A after oxidation. The graphite facilitated the reduction of MCO and promoted its densification.

Fuel cell systems of the embodiments of the present disclosure are designed to reduce greenhouse gas emissions and have a positive impact on the climate.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A method of forming a protective layer on an interconnect for an electrochemical cell stack, comprising:
coating at least one side of the interconnect with a metal oxide powder to form a protective layer;
sintering the coated interconnect in an inert atmosphere to at least partially reduce the protective layer; and
oxidizing the sintered interconnect in an oxidizing atmosphere to oxidize and densify the protective layer.

2. The method of claim 1, wherein the step of oxidizing is conducted at a higher temperature than the step of sintering.

3. The method of claim 2, wherein the step of oxidizing is conducted at a temperature of at least 950° C. and the step of sintering is conducted at a temperature of less than 950° C.

4. The method of claim 1, wherein the oxidized protective layer comprises a spinel phase.

5. The method of claim 4, wherein the metal oxide powder comprises:
a first component selected from copper oxide, nickel oxide, cobalt oxide, or a combination thereof; and
a second component selected from iron oxide, manganese oxide, or a combination thereof.

6. The method of claim 5, wherein the sintering comprises reducing at least 95 wt % of the first component and less than 5 wt % of the second component.

7. The method of claim 4, wherein the spinel phase comprises:
Mn₂₋ₓCo₁₊ₓO₄, wherein 0≤x≤1;
Cu_{0.5+x}Mn_{2.5-x}O₄, wherein 0≤x≤1; or
NiCo₂₋ₓFeₓO₄, wherein 0≤x≤1.

8. The method of claim 4, wherein the spinel phase comprises (Mn, Co, Fe)₃O₄, (Mn, Co, Cu)₃O₄, (Mn, Co, Ce)₃O₄, (Mn, Co, Cu, Ce)₃O₄, (Mn, Fe, Cu)₃O₄, or (Mn, Co, Fe, Cu)₃O₄.

9. The method of claim 4, wherein the spinel phase comprises Mn_{1.5}Co_{1.5}O₄, Mn_{1.475}Co_{1.475}Ce_{0.05}O₄, Ni_{0.9}Fe_{2.1}O₄, NiCoFeO₄, Cu_{1.3}Mn_{1.7}O₄, CuMn₂O₄, MnCu_{0.5}Co_{1.5}O₄, MnCo_{1.7}Fe_{0.3}O₄, CoFe₂O₄, MnCo_{1.7}Cu_{0.3}O₄, Mn_{1.4}Co_{1.4}Cu_{0.2}O₄, Mn₂Fe_{0.7}Mg_{0.1}Cu_{0.1}Y_{0.1}O₄, or Cu_{0.77}Ni_{0.45}Mn_{1.78}O₄.

10. The method of claim 1, wherein:
the interconnect comprises a chromium-iron alloy or a stainless steel interconnect comprising an air side comprising air channels and a fuel side comprising fuel channels; and
the protective layer is disposed on the air side of the interconnect.

11. The method of claim 1, wherein the coating comprises a wet coating method.

12. The method of claim 1, wherein the inert atmosphere comprises at least one of nitrogen or inert gas.

13. The method of claim 12, wherein the inert atmosphere contains less than 0.1 volume percent of oxidizing gas or reducing gas.

14. The method of claim 1, further comprising assembling the interconnect into the electrochemical cell stack containing electrochemical cells.

15. The method of claim 14, wherein the sintering occurs before assembling the interconnect into the electrochemical cell stack, and wherein the oxidizing comprises oxidizing the sintered interconnect in the electrochemical cell stack.

16. The method of claim 14, wherein:
the sintering comprises sintering the coated interconnect in the electrochemical cell stack; and
the oxidizing comprises oxidizing the sintered interconnect in the electrochemical cell stack.

17. The method of claim 14, wherein:
the sintering comprises sintering the coated interconnect in a furnace containing the inert atmosphere before assembling the interconnect into the electrochemical cell stack; and
the oxidizing comprises oxidizing the sintered interconnect in a furnace containing the oxidizing atmosphere before assembling the interconnect into the electrochemical cell stack.

18. The method of claim 14, wherein the electrochemical cell stack comprises a solid oxide fuel cell stack, and the electrochemical cells comprise solid oxide fuel cells.

19. The method of claim 14, wherein the electrochemical cell stack comprises a solid oxide electrolyzer cell stack, and the electrochemical cells comprise solid oxide electrolyzer cells.

20. The method of claim 1, wherein the metal oxide powder further comprises an adhesion promoter comprising Mg, Y, Ce, La, Sm, Zr, or a combination thereof.

21. The method of claim 1, wherein the protective layer further comprises at least one of an organic material or a carbon material prior to the step of sintering.

22. The method of claim 21, wherein the protective layer comprises at least 2 wt % of the organic material.

23. The method of claim 22, wherein the organic material comprises 3 wt % to 7 wt % ethyl cellulose.

24. The method of claim 21, wherein the protective layer comprises at least 0.2 wt % of the carbon material.

25. The method of claim 24, wherein the carbon material comprises 1 wt % to 5 wt % of graphite.

26. The method of claim 21, wherein the protective layer further comprises both the organic material and the carbon material prior to the step of sintering.
